(19) United States
(12) Patent Application Publication
(10) Pub. No.: US 2017/0308675 A1
(43) Pub. Date: Oct. 26, 2017

(54) A method and an apparatus for dispensing drugs and/or vitamins into dispensing units

(71) Applicant: NewIcon Oy, Kuopio (FI)

(72) Inventor: Ossi Parviainen, Kuopio (FI)

(73) Assignee: NewIcon Oy, Kuopio (FI)

(21) Appl. No.: 15/523,396

(22) PCT Filed: Oct. 28, 2015
(86) PCT No.: PCT/FI2015/050741

§ 371 Date: Apr. 30, 2017

(30) Foreign Application Priority Data
Oct. 30, 2014 (FI) 20145952

(51) Int. Cl. G06F 19/00; B65B 43/44; B65B 35/36; A61J 7/00; B65B 7/28; B65B 5/10; B65B 57/00; B65B 35/46

(52) U.S. Cl. CPC G06F 19/3462; B65B 57/00; B65B 43/44; B65B 35/46; A61J 7/0084; B65B 7/28; B65B 5/105; B65B 35/36

(57) ABSTRACT

“The invention relates to a method for dispensing drugs and/or vitamins to dispensing units, in which method one or more dispensing units are placed onto a drug dispensing tray. In the method according to the invention, the drugs and/or vitamins are dispensed into the dispensing units by a robot having an arm or a corresponding movable means, whose tip is equipped with a dispensing device for feeding drugs and/or vitamins in relation to it, the robot moving the dispensing device in relation to the drug dispensing tray for dispensing drugs into the dispensing units. The invention also relates to an apparatus for dispensing drugs and/or vitamins into dispensing units.”

### FIELD OF THE INVENTION

The invention relates to a method and an apparatus for dispensing drugs and/or vitamins into dispensing units.

### BACKGROUND OF THE INVENTION

In departments of hospitals and health clinics, drugs are still dispensed into dispensing units primarily manually. In e.g. a central hospital, the quantity of drugs to be dispensed is very large. Therefore, this takes a lot of working time and incurs significant costs for the hospital. Moreover, manual dispensing of drugs always involves the risk of a human error. It has often been suggested that human errors in the dispensing of drugs (together with other malpractices) would nowadays be even the third most common cause of death in Finland.

In recent years, some manufacturers of pharmaceutical and hospital supply products and devices have developed automated drug dispensing devices. These have made it possible to improve the safety in dosing and dispensing of drugs compared with manual dosing and dispensing. In these known methods, the drugs are usually dosed in plastic bags or other disposable mini packages which are then delivered directly to patients, or the drugs are unpacked into separate dispensing units, because it may be very difficult for the patient, weakened by illness and/or old age, to open e.g. closed plastic bags. As a result, the processes and the apparatuses required for implementing them are relatively complex, difficult to implement, and expensive in view of the operating and acquisition costs, among other things because of the handling of the packages and the constant need of packaging material. Moreover, in the present automatic drug dispensing apparatuses, different drugs are often guided via a common feeder channel into the drug dispensing units or dose bags. Such a way of operation has the drawback that the common feeder channel involves a risk of cross-contamination of drugs, i.e.

mixing of residues of drugs that have passed the feeder channel earlier, with drugs passing the feeder channel later on. One such system of prior art for dispensing drugs to patients is presented in patent application publication US 2010/256808 A1.

### BRIEF SUMMARY OF THE INVENTION

It is an aim of the invention to provide a new method for dispensing drugs and vitamins automatically into drug dispensing units, requiring no disposable packages and packaging materials needed for them, and enhancing the efficiency and safety of automatic dispensing of drugs as well as further reducing the costs incurred by the dispensing of drugs and/or vitamins. Further, it is an aim of the invention to provide an apparatus for dispensing drugs into drug dispensing units according to the method of the invention.

The aim of the invention is achieved by the method and the apparatus according to the invention, because the drugs are dispensed directly into dispensing units on a drug dispensing tray by such a dispensing device at the tip of an arm of an articulated robot that is moved by the articulated robot by moving its arm with respect to the drug dispensing tray, and from which the drugs are dropped directly into the dispensing units which are placed ready on the drug dispensing trays, with which they are brought to the patients at the stage of dispensing the drugs. To put it more precisely, the method according to the invention is characterized in what will be presented in the independent claim 1, and the apparatus according to the invention is characterized in what will be presented in the independent claim 6. Dependent claims 2 to 5 will present some advantageous embodiments of the method according to the invention, and dependent claims 7 to 10 will present some advantageous embodiments of the apparatus according to the invention.

The method and the apparatus according to the invention have the advantage of simplifying the apparatus used for automatic dispensing of drugs, because the dispensing into the dispensing units on the drug dispensing trays is performed directly into dispensing units on the drug dispensing tray by means of a dispensing device placed at the tip of the arm of an articulated robot and movable with respect to the drug dispensing trays. Owing to this, the apparatus required for the dispensing is simplified, and the dispensing can be performed without conveying different drugs in a common feed channel, wherein the possibility of exposure to cross-contamination and the resulting risks to the patients' health are significantly reduced. Furthermore, this method and apparatus do not require temporary packing of drugs into plastic bags to be dispensed to patients at the dispensing step, but the drugs can be dispensed directly into dispensing units which are delivered to patients and from which the drugs can be taken without opening any plastic bags. This simplifies the work and e.g. reduces the costs of materials relating to the dispensing of drugs.

### DESCRIPTION OF THE DRAWINGS

In the following, the invention will be described in more detail with reference to the appended drawings, in which

FIG. 1 shows an apparatus according to the invention for dispensing drugs and/or vitamins, and

FIG. 2 is a chart showing a process for arranging centralized dispensing of drugs and/or vitamins between a pharmacy and the departments of a hospital or a health clinic.

### DETAILED DESCRIPTION OF THE INVENTION

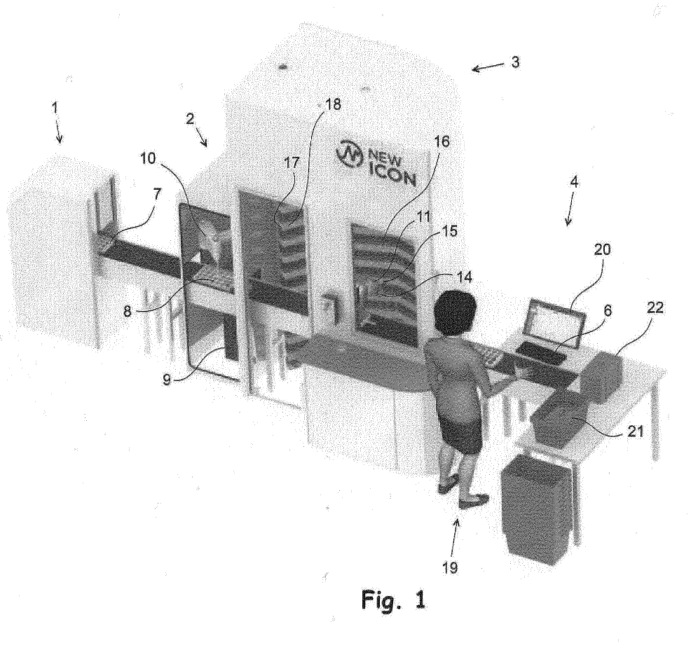

The apparatus shown in FIG. 1 comprises a magazine 1 of drug dispensing trays, a station 2 for adding dispensing units, a dosing station 3, as well as a main dispensing station 4. In addition, the apparatus comprises a conveyor 5 for trays, and a computer 6 for controlling the functions of the whole apparatus.

The conveyor 5 for trays is, for example, a belt conveyor, a slat-type conveyor, or another corresponding conveyor from the magazine 1 of drug dispensing trays to the main dispensing station 4 so that the station 2 for adding dispensing units and the dosing station 3 are located therebetween. In the case of the apparatus of FIG. 1, the conveyor 5 for trays is a uniform conveyor, the magazine 1 for drug dispensing trays being placed at its first end and the main dispensing station 4 at its second end. The station 2 for adding dispensing units and the dosing station 3 are placed therebetween.

The magazine 1 of drug dispensing trays is a part of the apparatus to which used drug dispensing trays 7 are returned and which feeds new drug dispensing trays 7 to the conveyor 5 for trays. In the magazine 1 of drug dispensing trays, the drug dispensing trays 7 are placed on top of each other above the conveyor 5 for trays. The feeding is configured to take place so that the next drug dispensing tray 7 to be fed to the conveyor 5 for trays is always the lowermost one in the magazine 1 of drug dispensing trays, and when this drug dispensing tray 7 is fed to the conveyor 5 for trays, it is lowered onto the conveyor 5 for trays from above, so that the next drug dispensing tray 7 above it will be the next drug dispensing tray 7 to be fed to the conveyor 5 for trays. In the magazine 1 of drug dispensing trays, the drug dispensing trays 7 are preferably always placed in the same direction and aligned so that they are always placed in the same position, one by one, one after the other, onto the conveyor 5 for trays, so that they will always be in the same position in the later steps of the process. The feeding takes place so that the next new drug dispensing tray 7 is always brought to the dosing station 3 after the dosing into the dispensing units 8 on the preceding drug dispensing tray 7 has been completed.

The drug dispensing trays 7 are normally rectangular or circular, and they typically have e.g. 36 or 48 seats for receiving the same number of dispensing units 8. The seats are, for example, recesses formed in the drug dispensing tray 7 and having an inner surface in the shape of the dispensing units. For example, if the dispensing units 8 are conventional “dosing cups” (as in the embodiment shown in FIG. 1), the seat has an inner diameter corresponding to the outer diameter of the dispensing unit, and is slightly downwards tapering so that such a dispensing unit 8 is stable on the drug dispensing tray 7 without tipping over and moving even if the drug dispensing tray 7 were tilted.

From the magazine 1 of drug dispensing trays, the empty drug dispensing trays 7 are moved to the station 2 for adding dispensing units 8. This part of the apparatus comprises a storage 9 of dispensing units and a robot 10 for picking up dispensing units 8 from the storage 9 of dispensing units and placing them on the drug dispensing trays 7, one or more dispensing units 8, or e.g. one row of dispensing units 8 at a time. In the case of several dispensing units 8, a gripper is provided at the tip of the arm of the robot 10, by which the robot 10 can fetch several dispensing units 8 at a time. Alternatively, this can also take place so that the dispensing units 8 to be placed on one drug dispensing tray 7 are first fitted by a suitable feeding mechanism into a vertically movable inserting device which will place all the dispensing units 8 on the drug dispensing tray 7 by e.g. one vertical motion after the next drug dispensing tray 7 has arrived at the station 2 for adding drug dispensing units.

From the station 2 for adding drug dispensing units, the drug dispensing trays 7 are moved by the conveyor 5 for trays to the dosing station 3. At the dosing station 3, the drugs and/or vitamins are automatically dosed into the dispensing units 8 on the drug dispensing trays 7 by the robot 11 at the dosing station 3.

In the apparatus shown in FIG. 1, the dosing station 3 comprises a dosing space 12 enclosed by walls, a storage 13 of dispensing cassettes placed in the dosing space 12, and a robot 11 with a particular dispensing device 15 at the tip of its arm 14 for dispensing drugs and/or vitamins by means of dispensing cassettes 16 operated by the dispensing device 15. However, the dosing station 3 does not necessarily need to be a space enclosed by walls, but it can also be partly enclosed, or for example merely a space enclosed by safety guards where necessary. The dispensing device 15 is equipped with the necessary actuators by which the dispensing cassettes 16 containing drugs and/or vitamins are connectable to the dispensing device 15 so that the drugs and/or vitamins in the dispensing cassette 16 can be dispensed to a certain area with respect to the dispensing device 15 at the tip of the arm of the robot 11. The dispensing cassette 16 has a container into which drugs and/or vitamins can be added e.g. directly from the drug packages supplied by the pharmaceutical manufacturer, via a closable opening in the container of the dispensing cassette. Normally, only one type of drug or vitamin is contained in one dispensing cassette 16.

The dispensing cassettes 16 operated by the dispensing device 15 are of such a type where the dispensing takes place by rotating a dispensing member in the dispensing cassette 16. For this, the dispensing device 15 at the tip of the arm 14 of the robot 11 comprises a rotating device connectable to the rotatable dispensing member of the dispensing cassette, by which the dispensing member of the dispensing cassette 16 can be rotated for dispensing drugs and/or vitamins from the dispensing cassette 16. Typically, upon dispensing, one full rotation of the dispensing member makes one drug or vitamin dose (pill or tablet) drop to a given point below the dispensing device 15. Thus, when the dispensing device 15 is moved to a dispensing unit 8 on the dispensing tray 7 by moving the arm 14 of the robot 11, a desired quantity of medicine can be dropped from said dispensing cassette 16 into this dispensing unit 8 by rotating the dispensing means of the dispensing device 15 a desired number of rotations.

The dispensing device 15 fastened to the arm of the robot 11 is also implemented so that the robot 11 can replace the dispensing cassette 16 in the storage 13 of dispensing cassettes at the back of the dosing space 12. For this, the dispensing device 15 is equipped with the necessary actuators for removing the dispensing cassette 16 to be left in the storage 13 of dispensing cassettes from the dispensing device 15 when the dispensing device 15 is in the storage 13 of dispensing cassettes for returning the dispensing cassette 16 back to the storage 13 of dispensing cassettes, and for fastening a new dispensing cassette 16 to the dispensing device 15 when the dispensing device 15 is brought to said new dispensing cassette 16 to be introduced in the dispensing device 15.

As shown in FIG. 1, the storage 13 of dispensing cassettes comprises shelves 17 on top of each other, having compartments 18 for dispensing cassettes 16, next to each other and open at the front. In the embodiment shown in FIG. 1, the shelves 17 are arranged in a C shape around the robot in such a way that the robot 11 is placed in the area between the conveyor 5 carrying drug dispensing trays 7, and the storage 13 of dispensing cassettes. The C shape of the storage 13 of dispensing cassettes is implemented in such a way that the robot 11 reaches to all the dispensing cassettes 16 in the storage 13 of dispensing cassettes. So that the robot 11 can also fetch dispensing cassettes 16 from shelves 17 clearly higher or lower than it, the robot 11 can be fastened to the dosing station 3 by means of a vertically movable lifting mechanism or a vertical guide so that the robot 11 can be moved vertically up and down when the dispensing cassette 16 to be picked up is placed clearly higher or lower than the level of the conveyor 5 for trays (in case of a high storage of dispensing cassettes). Alternatively or in addition, in an embodiment of this type, the robot 11 can be fixed and the shelves 17 of the storage 13 of dispensing cassettes can be implemented to be vertically movable, for example by fastening them to a chain conveyor rotating in the vertical direction. The robot 11 can be instructed to know which dispensing cassette 16 is placed on each shelf 17 and in each compartment, and/or the dispensing cassettes 16/compartments can have an indicator (e.g. RFID tag or bar code) which is read by a reader in connection with the dispensing device 15 or at the tip of the arm of the robot 11, to find out the location of the compartment and/or the the drug or vitamin in the dispensing cassette 16, and which can be used by a computer 6 controlling the robot 11 to make sure that the robot 11 always picks up the dispensing cassette 16 that contains the correct drug to be dispensed, from the storage 13 of dispensing cassettes.

The robot 11 at the dosing station 3 can be any articulated robot but also a robot of another type having an arm 14 for actuating the dispensing device 15 to pick up a dispensing cassette 16 from the storage 13 of dispensing cassettes, for dispensing drugs into the dispensing units 8 on the dispensing tray 7, and for returning the dispensing cassette 16 to the storage 13 of dispensing cassettes by bringing the dispensing device to that shelf 17 and compartment 18 of the storage 13 of dispensing cassettes, where said dispensing cassette 16 is stored.

After the dosing station 3, the drug dispensing trays 7 are moved by the conveyor 5 for trays to the main dispensing station 4 where the conveyor 5 of trays ends in the embodiment of FIG. 1.

The main dispensing station 4 is equipped with a computer 6 controlling the operation of the whole apparatus, as well as typically the work place 19 of the person controlling and monitoring the apparatus. At the main distribution station 4, the drug dispensing trays 7 with the doses ready are checked by comparing the tray specific prescription and the contents of the drug dispensing units 8 on the drug dispensing tray 7. For this purpose, a list of drugs dosed on said drug dispensing tray 7 is displayed on the display 20 of the computer 6 at the main dispensing station 4, with respect to the drug dispensing tray 7 arrived at the main dispensing station 4. At this stage, drugs possibly still missing from the drug dispensing tray 7 can be supplemented manually at the main dispensing station 4, if desired. Normally, the objective is a situation in which at least 80% of the drugs are dosed automatically at the dosing station 3, and the rest are dosed manually at the main dispensing station 4 or later in the place of administration, for example in a drug dispensing room of a hospital before administering the drugs to the patients.

At the main dispensing station 4, the supplemented drug dispensing trays 7 are finally packed in suitable means of transport, such as transport boxes 21 of FIG. 1 to be transported manually or automatically, a shuttle of pneumatic mail, or an automated guided vehicle (typically when the transfer of drugs takes place indoors only, for example within a hospital), to be transported to departments of a hospital or a health clinic, or directly to patient rooms, for administration to patients. In the embodiment of FIG. 1, each dispensing tray 7 is closed by one uniform lid 22 before packing the dispensing tray into a transport box 21. If pneumatic mail is used for the transport, the dispensing trays 7 may have a circular shape so that the space of the shuttle which typically has a circular cross-section can be utilized better. The filled means of transport are then sent to the address where said drugs are to be delivered. Therefore, the completed drug dispensing trays 7 are always placed so that said means of transport would preferably have only one destination so that it would not have to be forwarded several times from one place to another. However, if such a situation is unavoidable, the drug dispensing trays 7 are placed in such an order in the means of transport that the first drug dispensing tray 7 will always be the one addressed to the next destination of the transport box 21, shuttle or automated guided vehicle. This is to avoid screening out drug dispensing trays 7 from other drug dispensing trays 7 on top of each other.

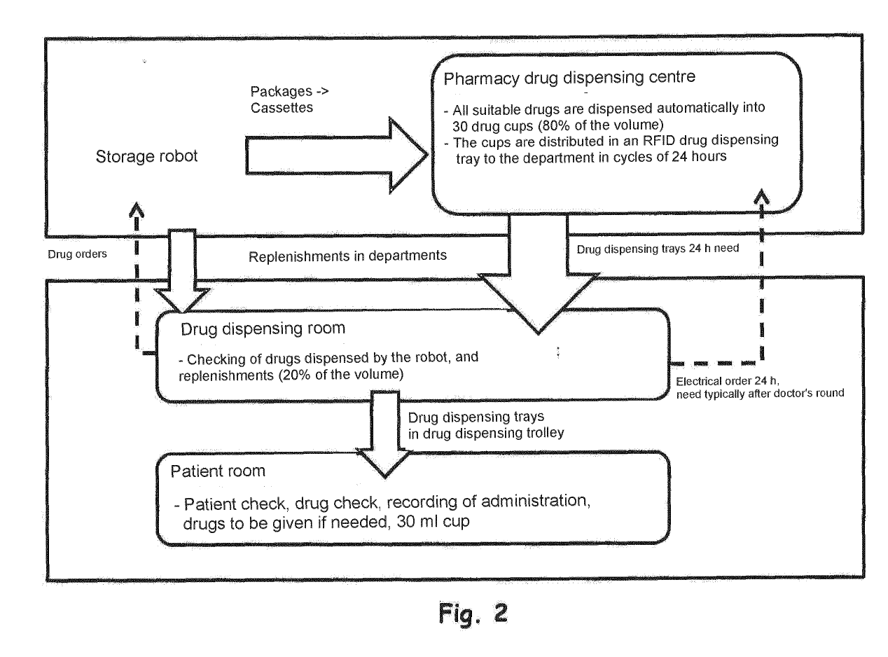

FIG. 2 is a chart showing an example of the use of an apparatus according to FIG. 1 in so-called centralized drug dispensing between a pharmacy and a hospital or a health clinic. In such an arrangement, the apparatus of FIG. 1 is placed in a pharmacy serving a hospital. At the pharmacy, at least 80% of the drugs and/or vitamins are dosed fully automatically, by the apparatus of FIG. 1, to be ready on drug dispensing trays 7, and are packed in e.g. transport boxes 21, in which the drugs, ready dosed in drug dispensing units on the drug dispensing trays, are delivered to the drug dispensing rooms at the departments of the hospital. In the drug dispensing room, the dispensing of the rest of the drugs (normally not more than 20% of the drugs to be administered) are dispensed into the dispensing units 8 on the drug dispensing trays arrived from the pharmacy. The manual dispensing normally relates to less common drugs and/or drugs which are already available in the drug dispensing room of the hospital. The complete drug dispensing trays 7 supplemented with the missing drugs are now delivered to the patient rooms in special drug dispensing carts equipped with an apparatus for identifying the drug dispensing trays 7 and the dispensing units 8 in them by means of an identifying device to be brought in connection with the drug dispensing trays 7 so that it is known which drug dispensing unit 8 contains the medicine for each patient, and thereby how the dispensing units 8 should be dispensed to the different patients in said patient room. After the dispensing of the drugs, the empty drug dispensing trays 7 are returned to the pharmacy where they are returned to the magazine 1 of drug dispensing trays in the apparatus of FIG. 1. In connection with the dispensing, the device in the dispensing cart registers the dispensing. Because the computer in the dispensing cart is wirelessly connected (for example via a WLAN connection) or will be connected to the patient data system of the hospital later on, data about the performed dispensing of drugs is updated in the patient data system of the hospital without separate manual reporting.

The method and the apparatus according to the invention can be implemented in a variety of ways deviating from the example embodiment shown in FIG. 1. In some embodiments, e.g. the conveyor for trays can consist of several parts instead of one uniform conveyor. Moreover, the magazine of drug dispensing trays can be configured to function in a number of different ways. In some embodiments, the magazine of drug dispensing trays and the station for adding drug dispensing units can be combined in such a way that after the placement of a drug dispensing tray on the conveyor for trays, a robot or another suitable automated device in connection therewith will place dispensing units onto the empty dispensing tray before it is forwarded to the dosing station that is the next step in the apparatus. At the dosing station, the dispensing means of the dispensing device at the tip of the arm of the robot can also function in another way than by rotating. The dispensing means could be e.g. a piece provided in the dispensing cassette and moving back and forth in the vertical or horizontal direction, its one reciprocating motion resulting in the dropping of one drug dose off the dispensing cassette. Further in an embodiment of the method and the apparatus according to the invention, the dispensing of drugs at the dosing station can be configured to be performed by not one but two or more industrial robots so that e.g. the first industrial robot is responsible for the dispensing of pills, tablets and other drugs and/or vitamins of such type, another industrial robot is responsible for the dispensing of liquid drugs, and a third industrial robot is responsible for sealing the dispensing units containing liquid material with a lid, or for a corresponding auxiliary function needed. Moreover, for example the main dispensing station can be implemented in a way deviating from the above presented example embodiments e.g. so that some of the functions carried out there are fully automated. Typically, e.g. the packing of drug dispensing trays into transport boxes or shuttles could be such a function. The method and the apparatus according to the invention are thus not limited to the above presented example embodiments but they can be implemented in different ways within the scope of the appended claims.

1. A method for dispensing drugs and/or vitamins into dispensing units, in which method one or more dispensing units are placed on a drug dispensing tray, wherein the drugs and/or vitamins are dispensed into the dispensing units by an articulated robot having an arm, the tip of the arm being equipped with a dispensing device for feeding drugs and/or vitamins to a specific area in relation to it, and that the articulated robot having an arm applies the arm to move the dispensing device in relation to the drug dispensing tray, for dispensing drugs into the dispensing units.

2. The method according to claim 1, wherein the dispensing is performed at a dosing station and that several drug dispensing trays are stored in a magazine of drug dispensing trays, feeding drug dispensing trays onto a conveyor for trays guided to the dosing station.

3. The method according to claim 2, wherein the conveyor for drugs transports the drug dispensing trays from the magazine of drug dispensing trays to a station for adding dispensing units, from the station for adding dispensing units to a dosing station, and from the dosing station to a main dispensing station.

4. The method according to claim 2, wherein the dispensing units are added onto the drug dispensing tray at the station for adding dispensing units.

5. The method according to claim 2, wherein at the main dispensing station, the drug dispensing trays are checked, supplemented with drugs which are possibly still missing, packed as such into a means of transport, and sent by the means of transport to destinations for dispensing of the drugs and/or vitamins to patients.

6. An apparatus for dispensing drugs and/or vitamins into dispensing units, the apparatus comprising dispensing units, into which drugs and/or vitamins can be dosed, and drug dispensing trays, in which the dispensing units can be placed, wherein the apparatus comprises an articulated robot having an arm, the tip of the arm being equipped with a dispensing device configured to feed drugs and/or vitamins to a specific area in relation to the tip of the arm of the articulated robot, for dispensing drugs and/or vitamins into dispensing units on a drug dispensing tray, by applying the arm of the articulated robot to move the dispensing device in relation to the drug dispensing tray.

7. The apparatus according to claim 6, wherein the dispensing device is equipped with means for fastening and connecting a dispensing cassette containing drugs and/or vitamins to the dispensing device.

8. The apparatus according to claim 7, wherein the dispensing cassette is a dispensing cassette for feeding drugs and/or vitamins upon rotating of a rotatable dispensing means in the dispensing cassette, wherein the dispensing device comprises a rotating device connectable to the dispensing cassette, for rotating the dispensing means of the dispensing cassette.

9. The apparatus according to claim 6, wherein the apparatus comprises a magazine of drug dispensing trays, a station for adding dispensing units, a dosing station, and a main dispensing station, and that at least one conveyor for trays is arranged between the magazine of drug dispensing trays, the station for adding dispensing units, the dosing station, and the main dispensing station, for conveying drug dispensing trays from the magazine of drug dispensing trays to the station for adding dispensing units, from the station for adding dispensing units to the dosing station, and from the dosing station to the main dispensing station.

10. The apparatus according to claim 9, wherein the magazine of drug dispensing trays contains a storage for several drug dispensing trays, and that the magazine for drug dispensing trays contains a feeding device configured to feed drug dispensing trays onto the conveyor for trays automatically in a way required by the process of dispensing of drugs and/or vitamins to be dispensed.
